(19) United States
(12) Patent Application Publication
(10) Pub. No.: US 2022/0326944 A1
(43) Pub. Date: Oct. 13, 2022

(54) METHODS AND SYSTEMS FOR RESTORING A LINUX OPERATING SYSTEM ACROSS DIFFERENT LINUX ENVIRONMENTS

(71) Applicant: Wanclouds Inc., Santa Clara, CA (US)

(72) Inventors: Faiz M. KHAN, Santa Clara, CA (US); Farrukh SHABBIR, Santa Clara, CA (US)

(21) Appl. No.: 17/224,124

(22) Filed: Apr. 7, 2021

(51) Int. Cl. G06F 8/76; G06F 8/60; G06N 20/00

(52) U.S. Cl. CPC G06F 8/76; G06F 8/60; G06N 20/00

(57) ABSTRACT

Methods and systems for restoring or migrating Linux operating system across different Linux environments are described. The method performed by server system includes discovering a plurality of software packages installed on a source Linux server in response to receiving a migration request of the source Linux server to a target Linux server. The method includes validating the plurality of software packages based on a validation dataset stored in a database and information associated with the discovered software packages. The information includes configuration and data paths associated with the plurality of software packages within the source Linux server. The method includes storing snapshots of the plurality of software packages into the database, in response to successful validation of the plurality of software packages. The method further includes migrating the plurality of software packages to the target Linux server based on the stored snapshots of the plurality of software packages.

### TECHNICAL FIELD

The present invention relates to the field of server migration and, more particularly to, electronic methods and complex processing systems for migrating or restoring a source Linux server to a target Linux server that may be running different versions or different Linux distributions.

### BACKGROUND

Currently, server migrations, backups, and restorations involve taking a snapshot or image of the entire boot volume of a source system and then converting it and reformatting it according to the desired target system. For example, migrating a Linux® server (Linux is a registered trademark of Linus Torvalds) running a Debian distribution from an on-premises server to a cloud system involves taking a snapshot of the entire disk, converting it to the desired cloud format, and restoring the same version of Debian. This process is expensive in terms of processing, bandwidth requirements, and it is a time-consuming process. Additionally, this process is prone to errors. Further, the process is limiting because one can only migrate the server when the distributions of the source and target systems are the same. In some scenarios, system drivers have to be updated to be compatible across different hardware and hypervisors, and sometimes, no system drivers are available at all, especially, for older versions.

Hence, there is a need for methods and systems for restoring a Linux server to another Linux server that may be running on different versions or different Linux distributions.

### SUMMARY

Various embodiments of the present disclosure provide methods and systems for restoring a Linux operating system across different Linux environments.

In an embodiment, a computer-implemented method is disclosed. The computer-implemented method performed by a server system includes discovering a plurality of software packages installed on the source Linux server, in response to receiving a migration request of a source Linux server to a target Linux server. The method includes validating the plurality of software packages based, at least in part, on validation dataset stored in a database and information associated with the discovered software packages. The information includes configuration and data paths associated with the plurality of software packages within the source Linux server. In response to successful validation of the plurality of software packages, the method includes storing snapshots of the plurality of software packages into the database. The method includes migrating the plurality of software packages to the target Linux server based, at least in part, on the stored snapshots of the plurality of software packages.

In another embodiment, a server system is disclosed. The server system includes a memory configured to store instructions, a communication interface, a processor in communication with the memory and the communication interface, and the processor is configured to execute the instructions stored in the memory and thereby cause the server system to discover a plurality of software packages installed on the source Linux server, in response to receiving a migration request of a source Linux server to a target Linux server. The server system is caused to validate the plurality of software packages based, at least in part, on validation dataset stored in a database and information associated with the discovered software packages. The information includes configuration and data paths associated with the plurality of software packages within the source Linux server. In response to successful validation of the plurality of software packages, the server system is further caused to store snapshots of the plurality of software packages into the database. The server system is caused to migrate the plurality of software packages to the target Linux server based, at least in part, on the stored snapshots of the plurality of software packages.

In yet another embodiment, a computer-implemented method for restoring Linux operating system across different Linux environments is disclosed. The computer-implemented method performed by a server system includes discovering a plurality of software packages installed on the source Linux server, in response to receiving a migration request of a source Linux server to a target Linux server. The method includes validating the plurality of software packages based, at least in part, on validation dataset stored in a database and information associated with the discovered software packages. The information includes configuration and data paths associated with the plurality of software packages within the source Linux server. In response to successful validation of the plurality of software packages, the method includes storing snapshots of the plurality of software packages into the database. The method includes migrating the plurality of software packages to the target Linux server based, at least in part, on the stored snapshots of the plurality of software packages.

### BRIEF DESCRIPTION OF THE FIGURES

For a more complete understanding of example embodiments of the present technology, reference is now made to the following descriptions taken in connection with the accompanying drawings in which:

FIG. 1 is an example representation of an environment related to at least some examples of the present disclosure;

FIG. 2 is a simplified block diagram representation of Linux servers and a server system with additional aspects, in accordance with an embodiment of the present disclosure;

FIG. 3 is a flow chart for a process flow for validating software packages and storing snapshots of software packages of a Linux server, in accordance with an embodiment of the present disclosure;

FIG. 4 is a flow chart for a process flow for migrating or restoring a source Linux server to a target Linux server, in accordance with an embodiment of the present disclosure;

FIG. 5 is a flow diagram of a computer-implemented method for migrating a plurality of software packages installed on a source Linux server to a target Linux server;

FIG. 6 is a simplified block diagram of a server (for example, Linux server), in accordance with an embodiment of the present disclosure; and

FIG. 7 shows a simplified block diagram of a client terminal capable of implementing the various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### OVERVIEW

Various embodiments of the present disclosure provide methods, systems, electronic devices, and computer program products for restoring or migrating a Linux operating system across the same or different Linux environments. The technical problem in existing solutions is that in the existing solution, snapshots of the entire boot volume are captured and then the snapshots are reformatted to migrate the entire boot volume to the desired target environment. This process is expensive, time- consuming, and is prone to errors since the boot volume includes software binaries and binary compatibility with the target environment and hardware is cumbersome.

Additionally, conventional approaches rely on system imaging that is prone to changes in the underlying hardware. Therefore, when the underlying hardware changes, the system may not work. To further elaborate, let us consider a scenario where a working email server is running on the 64bit source machine. The target system, where the working email server needs to migrate, is for some reason a 32bit machine. In the conventional approaches, the system image is not going to boot up on the target system because of the underlying hardware. In contrast, the present disclosure solves the above-mentioned technical problem by cleanly migrating or restoring the email server and booting the email server up as a properly working machine

More specifically, the present disclosure describes techniques and methodology for backing up a plurality of software packages installed on a Linux operating system and migrating them across multiple Linux environments. Translation of the software packages may or may not be done based on the requirements of the Linux environment that they are being migrated to.

In an example, the present disclosure describes a server system that is configured to perform restoration of a Linux server across multiple Linux environments. The server system includes at least a processor and a memory. The server system is configured to receive a migration request of a source Linux server to a target Linux server. In response, the server system is configured to trigger a discovery module of the source Linux server to discover a plurality of software packages installed on the source Linux server. In other words, the server system is configured to facilitate the discovery module implemented on the source Linux server to scan the whole server to find out all the software packages that are installed on the source Linux server.

The discovery module may send a package log file including information of the plurality of software packages associated with the source Linux server, to the server system. The server system is configured to validate the plurality of software packages based, at least in part, on the validation dataset and information of configurations and data paths of the discovered software packages. The validation is performed against a known set of dataset to compare the data from the discovery phase to determine the future steps required to process the snapshot. During the validation, the server system is configured to compare each of the plurality of software packages with the validation dataset. The validation dataset includes a set of software packages and their respective configuration and data paths that have been previously learned during past discovery processes. After the comparison, the server system is configured to determine a validation score associated with each of the plurality of software packages based, at least in part, on a machine learning (ML) model and the comparison.

The server system is configured to check whether the validation score associated with each of the plurality of software packages is greater than a predetermined threshold value. When validation scores associated with the plurality of software packages are greater than the predetermined threshold value, the server system stores snapshots associated with the software packages in a database. Thus, the present disclosure does not take a snapshot of the whole disk. It only takes snapshots of discovered packages configurations, its data and any other custom data directories specified by the user. For the packages that may fail validation because a configuration path may have changed, the user is prompted for providing the right path and the ML model updates the validation score.

More illustratively, in one scenario, when a validation score for a particular software package is less than the predetermined threshold value, the server system is configured to prompt a user input from the source Linux server to validate the particular software package. The user input may include information such as configuration and data paths manually filled up by a user (for example, IT professional) and a certain validation score for the particular software package set by the user. The server system may validate the particular software package based on the user input and store the snapshots.

The server system is configured to migrate or restore the plurality of software packages to the target Linux server based, at least in part, on the stored snapshots of the plurality of software packages. While restoring the software packages into the target Linux server, the validation step as discussed earlier is performed again. The purpose of this validation is to ensure that the restore process has been completed without any errors and conflicts.

Thereafter, the server system is configured to check if the versions and/or Linux distributions of the source and target Linux servers are the same or different. In an embodiment, when the versions/Linux distributions are found to be different, the server system is configured to translate the plurality of software packages. The plurality of software packages is translated to equivalent software packages to make them compatible with the target Linux server. Otherwise, the server system is configured to restore or migrate the validated software packages to the target Linux server without translation.

Without in any way limiting the scope, interpretation, or application of the claims appearing below, technical effects of one or more of the example embodiments disclosed herein is provisioning backup and migrations of Linux operating system across various Linux distributions irrespective of the versions and distributions of the source and target Linux servers. The present disclosure eliminates the hardware dependency between the source and target Linux machines by validating and translating the software packages before migrating them from the source Linux server to the target Linux server. This present disclosure eliminates the need to move binary packages from source to destination thus eliminating hardware dependency. Instead of moving packages, packages are reinstalled on destination system(s). This approach not only helps to migrate irrespective of underlying hardware but also helps update the software packages during the process. Further, the present disclosure enables upgrading the software packages into new versions during migrations by default, without needing to upgrade the whole system, which thereby eliminates the costly and expensive methods for performing Linux server updates. Furthermore, the present disclosure simplifies the process of containerizing applications. For example, PHP package version 5 is installed on the source machine and the user wants to update the source machine to version 7 on the destination machine. To do that, package metadata is discovered and transformed to be compatible with the updated version and then transferred to the destination machine.

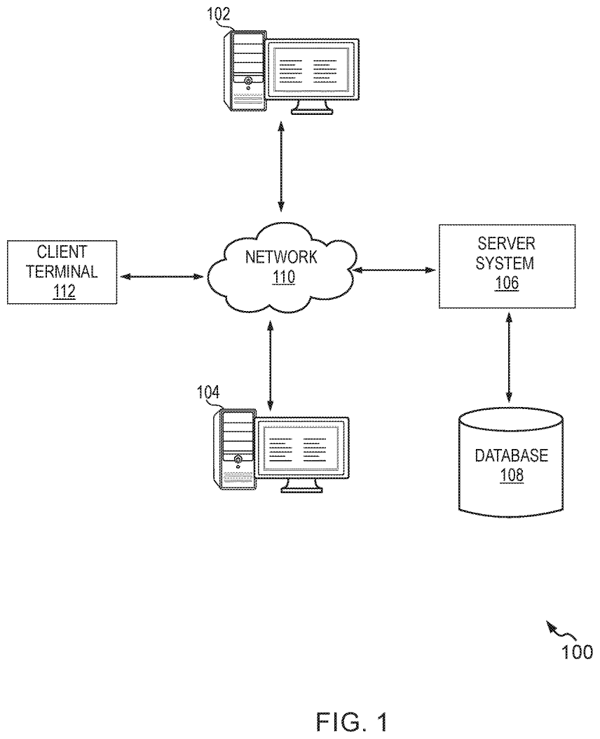

Various example embodiments of the present disclosure are described hereinafter with reference to FIGS. 1 to 7.

FIG. 1 is an example representation of an environment 100 related to at least some examples of the present disclosure. Although the environment 100 is presented in one arrangement, other embodiments may include the parts of the environment 100 (or other parts) arranged otherwise depending on, for example, a method for how to migrate, backup a Linux machine or server, and restore the Linux machine or server on another Linux machine that may even be running different versions or different distributions and across different underlying hardware or hypervisors, etc. The environment 100 generally includes a Linux server 102, a Linux server 104, a server system 106, a database 108 associated with and in communication with (and/or with access to) a network 110. The network 110 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among the entities illustrated in FIG. 1A, or any combination thereof.

Various entities in the environment 100 may connect to the network 110 in accordance with various wired and wireless communication protocols, such as, Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. The network 110 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof. For example, the network 110 may include multiple different networks, such as a private network made accessible by the Linux server 102, the Linux server 104, the server system 106, and the database 108, separately, and/or a public network (e.g., the Internet) through which the Linux server 102, the Linux server 104, the server system 106, and the database 108 may communicate. In some embodiments, the Linux server 102 and the Linux server 104 may, for example, be connected to the server system 106 via various wireless means such as, cell towers, routers, repeaters, ports, switches, and/or other network components that include the Internet and/or a cellular telephone (and/or Public Switched Telephone Network (PSTN)) network, and which include portions of the network 110.

In one embodiment, the Linux server 102 and the Linux server 104 may be implemented on a client device such as a desktop, a laptop, or the like. The Linux server 102 and the Linux server 104 may be running on any distribution such as Debian, Ubuntu, CentOS, Red Hat Enterprise Linux (RHEL) operating system, and the like. In an example, the Linux server 102 and the Linux server 104 may be running on different distributions having different versions. The Linux servers include a plurality of software packages installed on them.

In one embodiment, the client terminal 112 that is in communication with or directly connected with Linux server 102 may receive input from a user for the Linux servers to implement computing services. In one embodiment, the client terminal 112 may include any type or configuration of computing, mobile electronic, network, user, and/or communication devices that are or become known or practicable. Examples of the user device include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like. In one embodiment, the client terminal 112 is equipped with a migration application to generate user requests for migrating, backing up a machine or server running Linux operating system (OS), and restore the machine or server on another Linux machine that may even be running different versions or different distributions and across different underlying hardware or hypervisors.

In one embodiment, the server system 106 is configured to receive a user request from the client terminal 112 for migrating, backing up, or restoring the Linux operating system running on the Linux server 102 onto another Linux system (such as, Linux server 104). In response, the server system 106 is configured to control the migration, backup, and restoration of software packages installed on a Linux server (for example, the Linux server 102) to another Linux server or machine (e.g., target Linux server 104).

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally, or alternatively, a set of systems (e.g., one or more systems) or a set of devices (e.g., one or more devices) of the environment 100 may perform one or more functions described as being performed by another set of systems or another set of devices of the environment 100.

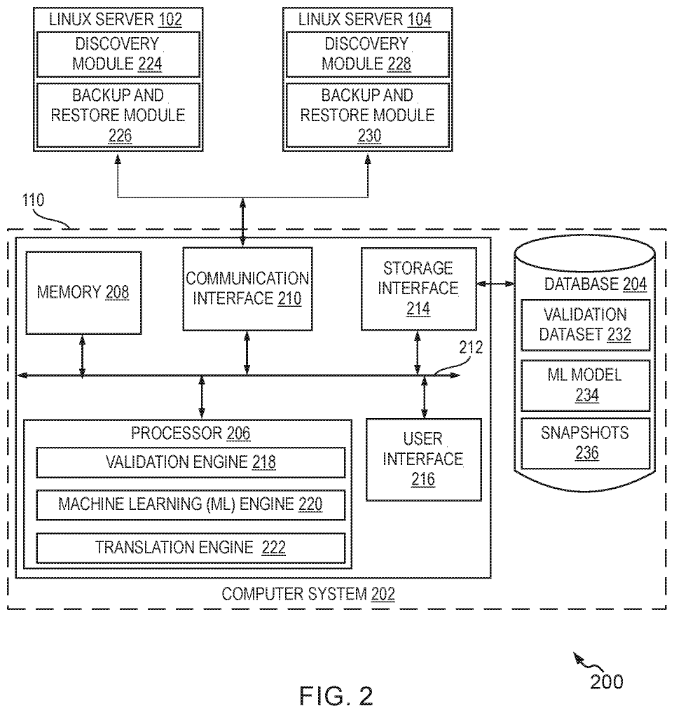

FIG. 2 is a simplified block diagram representation 200 of the Linux server 102, the Linux server 104, and the server system 106 with additional aspects, in accordance with an embodiment of the present disclosure. In some embodiments, the server system 106 is embodied as a cloud-based and/or SaaS-based (software as a service) architecture. As described above, the server system 106 is configured to migrate, backup a machine or server running Linux operating system, and restore it on another Linux machine that may even be running different versions or different distributions and across different underlying hardware or hypervisors.

In one example embodiment, the server system 106 is configured to migrate packages from the Linux server 102 (i.e., “source Linux server”, interchangeably used throughout the description) to the Linux server 104 (i.e., “target Linux server”, interchangeably used throughout the description). The source Linux server 102 contains its own installed packages that may need to be migrated to the target Linux server 104. In one example, the source Linux server 102 and the target Linux server 104 are operated in different versions or Linux distributions. In another example, the source Linux server 102 and the target Linux server 104 are operated in the same versions or Linux distributions. Examples of Linux distributions include Debian, Ubuntu, CentOS, Red Hat Enterprise Linux (RHEL), and so on.

In one embodiment, the server system 106 includes a computer system 202 and a database 204 (i.e., it is similar to the database 108 as shown in FIG. 1A). The computer system 202 includes at least one processor 206 for executing instructions, a memory 208, a communication interface 210, and a user interface 216. The one or more components of the computer system 202 communicate with each other via a bus 212.

In one embodiment, the database 204 is integrated within the computer system 202. For example, the computer system 202 may include one or more hard disk drives as the database 204. A storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one embodiment, the database 204 may include validation dataset 232, machine learning model (ML) model 234, and snapshots 236 of software packages for various Linux servers.

The processor 206 includes suitable logic, circuitry, and/or interfaces to execute computer-readable instructions for facilitating the migration of one or more packages associated with the source Linux server 102 to servers operating on Linux environments. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like. The memory 208 includes suitable logic, circuitry, and/or interfaces to store a set of computer-readable instructions for performing operations. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory 208 in the server system 106, as described herein. In some embodiments, the memory 208 may be realized in the form of a database server or a cloud storage working in conjunction with the server system 106, without deviating from the scope of the present disclosure.

The processor 206 is operatively coupled to the communication interface 210 such that the processor 206 is capable of communicating with remote device such as, the source Linux server 102, the target Linux server 104, etc. or with any entity connected to the network 110 (e.g., as shown in FIG. 1).

It is noted that the server system 106 as illustrated and hereinafter described is merely illustrative of an apparatus that could benefit from embodiments of the present disclosure and, therefore, should not be taken to limit the scope of the present disclosure. It is noted that the server system 106 may include fewer or more components than those depicted in FIG. 2.

In one embodiment, the processor 206 includes a validation engine 218, a machine learning (ML) engine 220, and a translation engine 222. It should be noted that components, described herein, can be configured in a variety of ways, including electronic circuitries, digital arithmetic and logic blocks, and memory systems in combination with software, firmware, and embedded technologies.

Further, the source Linux server 102 includes discovery module 224 and backup and restore module 226. In similar manner, the target Linux server 104 includes discovery module 228 and backup and restore module 230.

In one embodiment, the server system 106 may receive a user request to migrate the source Linux server 102 to the target Linux server 106. In another embodiment, the server system 106 may receive a user request to backing up the source Linux server 102 to a remote cloud storage (for example, the database 204). Upon receiving the user request, the processor 206 is configured to trigger the discovery module 224 of the source Linux server 102 to discover installed packages on the source Linux server 102.

The discovery module 224 includes suitable logic, circuitry, and/or interfaces to execute computer-readable instructions for discovering a plurality of software packages installed on the source Linux server 102 in an automated manner In other words, the discovery module 224 is configured to scan the plurality of software packages installed on the source Linux server 102 that needs to be migrated or backed up. In general, each software package delivers and maintains software for Linux-based computers. The Linux ecosystem depends on packages that are administered through software repositories. These files govern the addition, maintenance, and removal of programs on the computer.

The discovery module 224 can be a hardware or software tool developed with any kind of programming language for discovering packages and the associated configuration information to be migrated on the source Linux server 102.

The tool may probe infrastructure and resources of a computing environment in order to identify, characterize, and inventory software packages running on the computing environment's remote infrastructure. Such a tool may create a topological view of a computing environment that allows an administrator or other individual to identify dependencies among the software packages. In this way, the tool may provide insight into characteristics of a complex software package infrastructure.

The discovery module 224 is configured to scan and fetch all the software packages installed in the source Linux server 102. The discovery module 224 may further determine information such as configuration and data paths associated with the software packages of the source Linux server 102. The discovery module 224 is configured to send package log file including information associated with discovered packages to the validation engine 218, through an agent or an export mechanism for validation.

The validation engine 218 includes suitable logic, circuitry, and/or interfaces to execute computer-readable instructions for validating the software packages based, at least in part, on validation dataset 232 stored in the database 204 and the information associated with the discovered software packages of the source Linux server 102. The information associated with the discovered software packages of the source Linux server 102 is extracted from the package log file. The information may include, but not limited to, current configuration and data paths associated with the plurality of software packages within the source Linux server 102. The validation refers to checking the information regarding the software packages such as the data configurations and data paths of the software packages for migrating, restoring, or backing them up.

The validation engine 218 is configured to compare the information associated with the discovered software packages with validation dataset 232 stored in the database 204 (i.e., database 108). The validation dataset 232 may include a set of known datasets corresponding to all the software packages that have been previously learnt through discovery processes for various Linux systems. In particular, the validation dataset 232 includes, but is not limited to, configuration and data paths corresponding to a set of software packages that has been identified in past discovery process earlier.

The validation engine 218 is configured to validate the plurality of software packages based on the comparison of configuration and data paths of each software package of the source Linux server 102 with the validation dataset 232.

The ML engine 220 includes suitable logic, circuitry, and/or interfaces to execute computer-readable instructions for determining a validation score on where and how a specific package is deployed, for each discovered software packages of the source Linux server 102. In other words, the ML engine 220 is configured to calculate the validation score for each discovered software package based on the comparison of the configuration and data paths of the discovered software packages with the validation dataset.

The ML engine 220 implements a machine learning model that is trained on configuration and data paths of all the software packages learned in the past discovery processes for Linux systems. The ML engine 220 is configured to capture deployment patterns of all the software packages in multiple Linux operating environments. The machine learning (ML) model 234 utilizes previous software package discovery processes as historical data and topology data to identify how and where a specific software package is deployed. In one embodiment, the ML model is a reinforcement learning (RL) model with a feedback system that helps in identification of dependencies as well as associated data mapping. The RL model is trained using past software package discovery processes performed in various Linux distributions. It would be apparent to those skilled in the art that several of RL models may be applied to accomplish the spirit of the present disclosure.

The ML model 234 also engages a human subject matter expert to review and to increase quality of the ML model 234. For example, when a new software package is discovered, a user input is prompted to collect or confirm the configuration and data paths of the new software package. In response, the human subject matter expert (i.e., IT professional or System Administrator) confirms the configuration and data paths of the new software package and provides a certain probability score (i.e., validation score). As more discoveries are performed against the various Linux distributions, the server system 106 may come across the new software package, the ML model 234 may increase probability or validation score corresponding to the new software package with more hits on the same package location (i.e., the configuration and data paths), and hence an overall validation score for the new software package and its configuration and data paths is determined and learnt by the ML model 234.

The ML model 234 helps to tackle the unknown scenarios. For example, there is a new software package that just got released and has not been seen by the ML model 234 and configuration and data paths are not included in the validation dataset 232. So when a discovery is performed, this new software package is discovered and its configuration and data paths will be learnt. A probability score (i.e., validation score) is assigned and overall confidence is derived about the new software package. As more discoveries are performed and the same software package shows up the overall probability and confidence increases and now the server system 106 can restore the software package on a target machine in its proper location.

More illustratively, when a validation score for a particular software package is less than a predetermined threshold value, a user input is prompted to collect or confirm the configuration and data paths of the particular software package.

Once the validation engine 218 successfully validates the plurality of software packages and validation scores of the plurality of software packages are greater than the predetermined threshold value, the server system 106 is configured to trigger backup and restore module 226 of the source Linux server 102 to capture snapshots of all the validated software packages.

The backup and restore module 226 includes suitable logic, circuitry, and/or interfaces to execute computer-readable instructions for capturing snapshots of the validated software packages installed on the source Linux server 102, relevant data directories, and user configuration directories. The captured snapshots are stored either in a cloud or any other on-premise/remote storage system. In one example, the captured snapshots are stored in the database 204 at a predefined location. The backup and restore module 226 additionally may also capture any other user data location snapshot, if required. The snapshots may refer to backing up the current state of installed software packages and their respective configurations in a database for the use of migration or restoration onto the target Linux server 104. In one embodiment, the backup and restore module 226 takes the snapshots of the validated software packages on a periodic basis to capture any changes in the system and store the updated snapshots at the predefined location.

In one scenario, when versions and/or Linux distributions of the source Linux server 102 and the target Linux server 104 are similar, the processor 206 is configured to validate the software packages present in the stored snapshots of the source Linux server 102. Thereafter, when the software packages are validated, the processor 206 is configured to send an instruction signal to backup and restore module 230 of the target Linux server 104 for directly migrating the stored snapshots to the target Linux server 104.

In another scenario, when versions and/or Linux distributions of the source Linux server 102 and the target Linux server 104 are not the same, the processor 206 is configured to perform validation and translation of configuration and data paths for the stored software packages.

In one embodiment, the validation engine 218 is configured to compare the configuration and data paths of the stored software packages with the validation dataset 232. In one example, if the validation of any stored software package gets failed because a configuration path may have changed, the user is prompted for providing the right path, and the machine learning model updates the validation score of the stored software package, accordingly. Once the stored software packages are successfully validated, the translation engine 222 is configured to translate the configuration and data paths of the software packages according to the target Linux server 104. The translation may include one or a combination of data configuration translation, and data path translation.

The translation engine 222 includes suitable logic, circuitry, and/or interfaces to execute computer-readable instructions for translating the plurality of software packages of the source Linux server 102 into equivalent software packages compatible with the target Linux server 104. The translation engine 222 may access the software packages that have to be migrated from the source Linux server 102 to the target Linux server 104. Further, the translation engine 222 is configured to determine the versions and distributions of both the source Linux server 102 and the target Linux server 104.

Based on the versions and distributions, the translation engine 222 is configured to perform either data configuration translation or data path translation or both. In an embodiment, data configuration translation includes translating the package configuration data to make it compatible with the target Linux server. The package configuration data may include IP address, etc. For example, an email server configuration contains, IP address of the server it is deployed on. So, if the target Linux server has different IP addresses that need to be changed to make it compatible. Data path translation is usually required when the source Linux server 102 and the target Linux server 104 have different distributions.

For example, if the source Linux server 102 is a Linux machine running Ubuntu OS and the target Linux server is running CentOS, both servers have a software package installed that takes care of networking configuration. On Ubuntu OS its configuration location will be “/etc/network/interfaces” while on CentOS, it's configuration location will be “/etc/sysconfig/ifcfg-*”. This will require data path translation as well as data configuration translation, because both these distributions have different ways to specify network configurations. This operation is performed by translation engine 222.

Thereafter, the backup and restore module 230 of the target Linux server 104 is configured to restore or migrate the translated software packages into the target Linux server 104. In other words, the backup and restore module 230 is configured to install the translated software packages into the target Linux server 104.

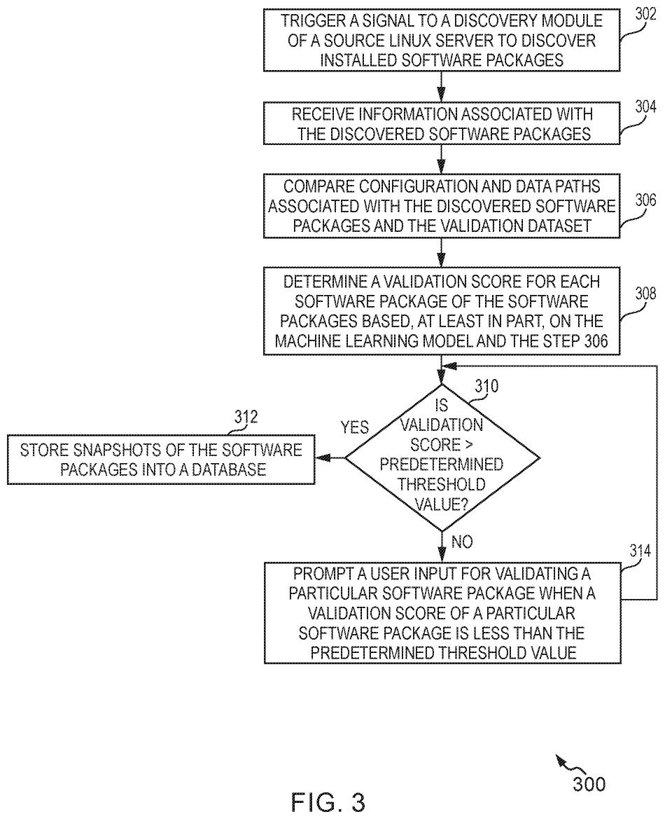

FIG. 3 is a flow chart 300 for a process flow for validating software packages and storing snapshots associated with the plurality of software packages of a Linux server (e.g., a source Linux server 102), in accordance with an embodiment of the present disclosure. The process depicted in the flow chart 300 may be executed by, for example, at least one server system such as the server system 106. Operations of the flow chart 300, and combinations of operation in the flow chart 300, may be implemented by, for example, hardware, firmware, a processor, circuitry and/or a different device associated with the execution of software that includes one or more computer program instructions. In one embodiment, the server system 106 may receive a user request to back up the source Linux server 102 to a remote cloud storage (for example, the database 204).

Upon receiving the user request, at 302, the server system 106 triggers a signal to the discovery module 224 of the source Linux server 102 to discover a plurality of software packages installed on the source Linux server 102. The discovery module 224 is configured to scan and fetch all the software packages installed in the source Linux server 102. The discovery module 224 may further determine information such as configuration and data paths associated with the software packages of the source Linux server 102.

At 304, the server system 106 receives the information associated with the discovered software packages. The information includes configuration and data paths of the discovered software packages within the source Linux server 102. In particular, the server system 106 may receive a package log file including information associated with discovered packages through an agent of the source Linux server 102 or an export mechanism. The plurality of software packages associated with the source Linux server 102 may include applications, boot files, and other information such as data configurations including IP addresses, data paths and the like. The plurality of software packages may be discovered by running a scan through boot files, program files, and the like.

At 306, the server system 106 compares the configuration and data paths associated with the discovered software packages and the validation dataset 232. The validation dataset 232 includes configuration and data paths of a set of software packages that are learnt in past discovery processes of various Linux distributions.

At 308, the server system 106 determines a validation score for each software package of the plurality of software packages based, at least in part, on the machine learning model and the step 306. The validation score for a particular software package is determined based on the configuration and the data path of the software package. The software package has well-defined data paths and all the required fields in the configuration, the ML model provides high validation score. Similarly, if the data paths are not well-defined and some fields are missing from the data configuration, the ML model may assign a less validation score. In one embodiment, the ML model is a reinforcement learning (RL) model with a feedback system that helps in identification of dependencies as well as associated data mapping.

At 310, the server system 106 checks whether the validation score associated with each software package is greater than the predetermined threshold value or not.

At 312, the server system 106 successfully validates the plurality of software packages and stores snapshots of the plurality of software packages into the database 204.

At 314, the server system 106 prompts a user input for validating a particular software package when a validation score of the particular software package is less than the predetermined threshold value. In other words, the server system 106 sends a request to a user associated with the source Linux server 102 or IT professional associated with the server system 106 to collect or confirm configuration and data paths of the particular software package when the ML model is unknown to the particular software package. The server system 106 prompts a user input from the user associated with the source Linux server 102 or the IT professional associated with the server system 106 to update the validation score. Thereafter, the process flow again goes back to 310.

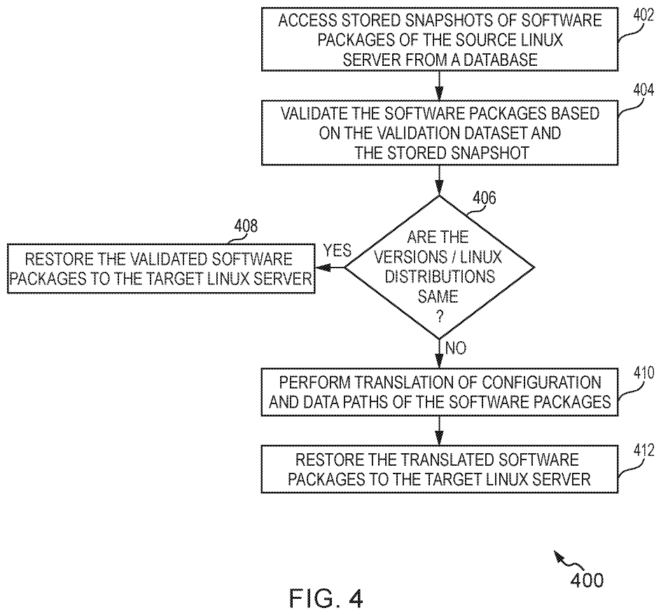

FIG. 4 is a flow chart 400 for a process flow for migrating or restoring the source Linux server 102 to target Linux server 104, in accordance with an embodiment of the present disclosure. The process depicted in the flow chart 400 may be executed by, for example, at least one server system such as the server system 106. Operations of the flow chart 400, and combinations of operation in the flow chart 400, may be implemented by, for example, hardware, firmware, a processor, circuitry and/or a different device associated with the execution of software that includes one or more computer program instructions.

At 402, the server system 106 accesses stored snapshots of software packages of the source Linux server 102 from the database 204. The snapshots may include the information associated with currently installed software packages in the Linux server and their respective configurations as described earlier.

At 404, the server system 106 validates the software packages based on the validation dataset and the stored snapshots. The purpose of this validation is to ensure that the restore process has been completed without any errors and conflicts.

At 406, the server system 106 checks whether versions and/or Linux distributions of the source Linux server 102 and the target Linux server 104 are the same or not. When the versions and/or Linux distributions of the source Linux server 102 and the target Linux server 104 are the same, the process flow goes to operation 408, otherwise, the process flow goes to operation 410.

At 408, the server system 106 restores or migrates the validated software packages to the target Linux server 104 without translation.

At 410, the server system 106 performs translation of configuration and data paths for the software packages. Based on the versions and/or Linux distribution related to source Linux server 102 and the target Linux server 104, the server system 106 performs either (a) configuration translation or (b) data path translation or both.

In an embodiment, the configuration translation includes translating the package configuration data to make it compatible with the target Linux server 104. The package configuration data may include IP address, etc. For example, an email server configuration contains IP address of the server it is deployed on. So, when the target Linux server 104 has different IP addresses, the same needs to be changed to make it compatible.

The data path translation is performed when the source Linux server 102 and the target Linux server 104 have different Linux distributions. For example, if the source Linux server 102 is a Linux machine running Ubuntu operating system and the target Linux server 104 is running CentOS operating system. Here, both Linux servers have installed a software package that takes care of networking configuration. On Ubuntu OS its configuration location will be “/etc/network/interfaces” while on CentOS OS its configuration location will be “/etc/sysconfig/ifcfg-*”. This will require data path translation as well as data configuration translation, because both these distributions have different ways to specify network configurations.

At 412, the server system 106 restores the translated software packages to the target Linux server 104. The translated software packages are compatible to be implemented on the target Linux server 104.

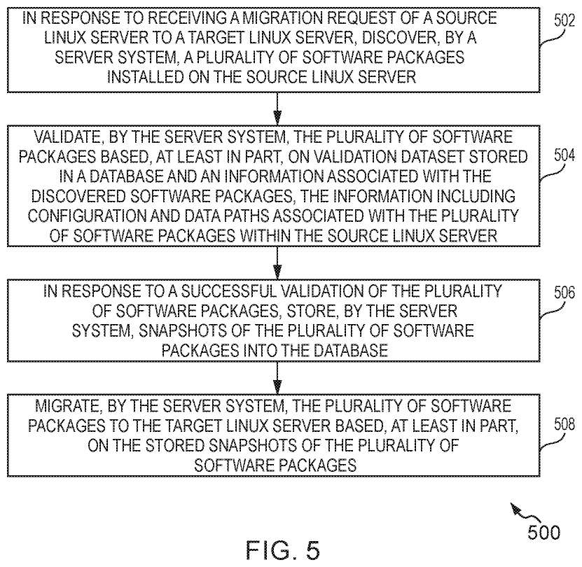

FIG. 5 is a flow diagram of a computer-implemented method for migrating a plurality of software packages installed on a source Linux server 102 to a target Linux server 104, in accordance of an embodiment of the present disclosure. The method 500 depicted in the flow diagram may be executed by, for example, the at least one server system such as the server system 106. Operations of the flow diagram of method 500, and combinations of operation in the flow diagram of method 500, may be implemented by, for example, hardware, firmware, a processor, circuitry and/or a different device associated with the execution of software that includes one or more computer program instructions. The method 500 starts at operation 502.

In response to receiving a migration request of the source Linux server 102 to the target Linux server 104, at the operation 502, the method 500 includes discovering a plurality of software packages installed on the source Linux server 102.

At operation 504, the method 500 includes validating the plurality of software packages based, at least in part, on validation dataset stored in a database 204 and an information associated with the discovered software packages. The information includes configuration and data paths associated with the plurality of software packages within the source Linux server 102.

At operation 506, the method 500 includes storing snapshots of the plurality of software packages into the database in response to a successful validation of the plurality of software packages.

At operation 508, the method 500 includes migrating the plurality of software packages to the target Linux server 104 based, at least in part, on the stored snapshots of the plurality of software packages.

The sequence of operations of the method 500 need not be necessarily executed in the same order as they are presented. Further, one or more operations may be grouped and performed in form of a single step, or one operation may have several sub-steps that may be performed in parallel or in sequential manner

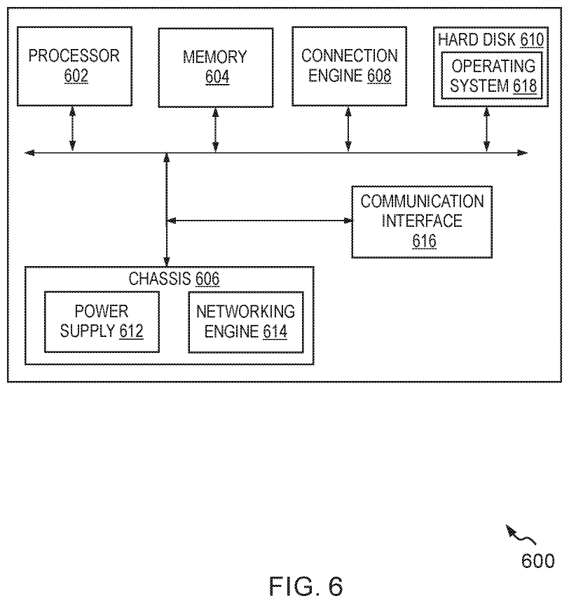

FIG. 6 is a simplified block diagram of a server 600, in accordance with an embodiment of the present disclosure. The server 600 is generally illustrative of source and target Linux servers discussed above. Examples of computer systems include stand-alone and enterprise-class servers operating on LINUX-based operating systems. In one example, the server 600 is a datacentre server. The datacentre servers may be maintained by various institutions for seamlessly transmission of services to a plurality of users simultaneously. For example, web hosting, cluster computing, etc., may be performed by utilizing such datacentre servers. In another example, the server 6000 is a desktop computer. The server 600 includes a processor 602, a memory 604 and a chassis 604, and a communication interface 616. The server 600 may further include a connection engine 608 and hard-disk 610. The chassis 606 may further include power supply 612, and networking engine 614. Further, two or more components may be embodied in one single component, and/or one component may be configured using multiple sub-components to achieve the desired functionalities. Some components of the server 600 may be configured using hardware elements, software elements, firmware elements and/or a combination thereof.

The processor 602 may be configured to extract programming instructions from the memory 604 and operating system 618 (for example, Ubuntu) to provide various features for data processing. Further, two or more components may be embodied in one single component, and/or one component may be configured using multiple sub-components to achieve the desired functionalities. The connection engine 608 may be a hardware component managing all the wired connections in the server 600.

Further, the chassis 606 may be configured to perform non-core parts of the computing processes in the server 600. The power supply 612 may be configured to deliver the power as AC current based on the requirement to various components of the data centre server 600. The networking engine 614 may be a hardware component with external ports to which the communication interfaces such as communication interface 616 and other components such as processor and memory will connect. File system storage may be implemented via the hard disk 610 that is stored internally within chassis 606, and/or via a plurality of hard disks that are stored in an external disk array that may be accessed via a SCSI card or equivalent SCSI circuitry built into a motherboard. The machine instructions comprising the software components that cause processor(s) 602 to implement the operations of the present disclosure that have been discussed above will typically be distributed on memory 604 (or other memory media) and stored in the hard disk 610 until loaded into memory 604 for execution by processor(s) 602. Optionally, the machine instructions may be loaded via the connection engine 608 as a carrier wave file.

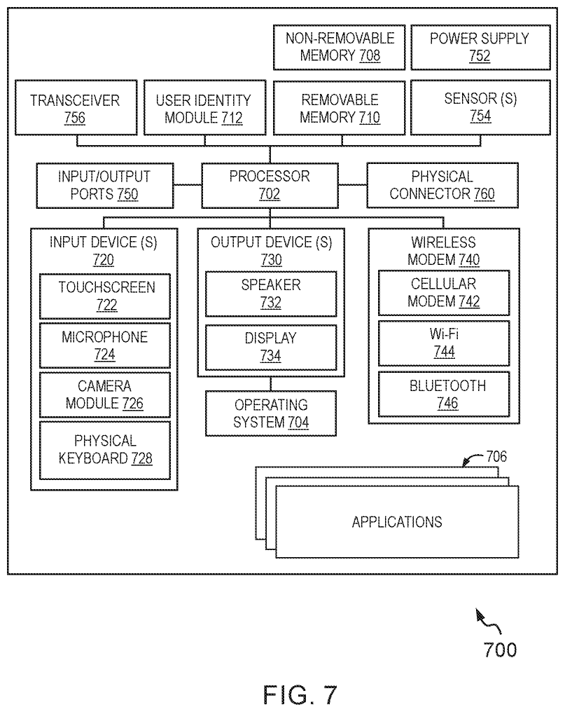

FIG. 7 shows a simplified block diagram of a client terminal 700 capable of implementing the various embodiments of the present disclosure. The client terminal 700 may be an example of the client terminal 112 shown in FIG.1. It should be understood that the client terminal 700 as illustrated and hereinafter described is merely illustrative of one type of device and should not be taken to limit the scope of the embodiments. As such, it should be appreciated that at least some of the components described below in connection with the client terminal 700 may be optional and thus in an example embodiment may include more, less or different components than those described in connection with the example embodiment of the FIG. 7. As such, among other examples, the client terminal 700 could be any of an client terminal or may be embodied in any of the client terminals, for example, cellular phones, tablet computers, laptops, mobile computers, personal digital assistants (PDAs), mobile televisions, mobile digital assistants, or any combination of the aforementioned, and other types of communication or multimedia devices.

The illustrated client terminal 700 includes a controller or a processor 702 (e.g., a signal processor, microprocessor, ASIC, or other control and processing logic circuitry) for performing such tasks as signal coding, data processing, image processing, input/output processing, power control, and/or other functions. An operating system 704 controls the allocation and usage of the components of the client terminal 700 and provides support for one or more programs such as accessing cloud computing services of virtual private clouds and requesting migration of packages from one Linux environment to another Linux environment described herein. The applications 706 may include common computing applications (e.g., telephony applications, email applications, calendars, contact managers, web browsers, messaging applications such as USSD messaging or SMS messaging or SIM Tool Kit (STK) application) or any other computing application.

The illustrated client terminal 700 includes one or more memory components, for example, a non-removable memory 708 and/or a removable memory 710. The non-removable memory 708 and/or the removable memory 710 may be collectively known as storage device/module in an embodiment. The non-removable memory 708 can include RAM, ROM, flash memory, a hard disk, or other well-known memory storage technologies. The removable memory 710 can include flash memory, smart cards, or a Subscriber Identity Module (SIM). The one or more memory components can be used for storing data and/or code for running the operating system 704. The client terminal 700 may further include a user identity module (UIM) 712. The UIM 712 may be a memory device having a processor built in. The UIM 712 may include, for example, a subscriber identity module (SIM), a universal integrated circuit card (UICC), a universal subscriber identity module (USIM), a removable user identity module (R-UIM), or any other smart card. The UIM 712 typically stores information elements related to a mobile subscriber. The UIM 712 in form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000,wideband CDMA (WCDMA) and time division-synchronous CDMA (TD-SCDMA), or with fourth-generation (4G) wireless communication protocols such as LTE (Long-Term Evolution).

The client terminal 700 can support one or more input devices 720 and one or more output devices 730. Examples of the input devices 720 may include, but are not limited to, a touch screen / a display screen 722 (e.g., capable of capturing finger tap inputs, finger gesture inputs, multi-finger tap inputs, multi-finger gesture inputs, or keystroke inputs from a virtual keyboard or keypad), a microphone 724 (e.g., capable of capturing voice input), a camera module 726 (e.g., capable of capturing still picture images and/or video images) and a physical keyboard 728. Examples of the output devices 730 may include, but are not limited, to a speaker 732 and a display 734. Other possible output devices can include piezoelectric or other haptic output devices. Some devices can serve more than one input/output function. For example, the touch screen 722 and the display 734 can be combined into a single input/output device.

A wireless modem 740 can be coupled to one or more antennas (not shown in the FIG. 7) and can support two-way communications between the processor 702 and external devices, as is well understood in the art. The wireless modem 740 is shown generically and can include, for example, a cellular modem 742 for communicating at long range with the mobile communication network, a Wi-Fi compatible modem 744 for communicating at short range with an external Bluetooth- equipped device or a local wireless data network or router, and/or a Bluetooth- compatible modem 746. The wireless modem 740 is typically configured for communication with one or more cellular networks, such as a GSM network for data and voice communications within a single cellular network, between cellular networks, or between the client terminal 700 and a public switched telephone network (PSTN).

The client terminal 700 can further include one or more input/output ports 750, a power supply 752, one or more sensors 754 for example, an accelerometer, a gyroscope, a compass, a global positioning system sensor (for providing location details) or an infrared proximity sensor for detecting the orientation or motion of the client terminal 700, a transceiver 756 (for wirelessly transmitting analog or digital signals) and/or a physical connector 760, which can be a USB port, IEEE 1294 (FireWire) port, and/or RS-232 port. The illustrated components are not required or all-inclusive, as any of the components shown can be deleted and other components can be added.

The disclosed method with reference to FIG. 5, or one or more operations of the method 500 may be implemented using software including computer- executable instructions stored on one or more computer-readable media (e.g., non- transitory computer-readable media, such as one or more optical media discs, volatile memory components (e.g., DRAM or SRAM)), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fibre optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 106 and its various components such as the computer system 202 and the database 204 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non- transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g., electric wires, and optical fibers) or a wireless communication line.

Various embodiments of the invention, as discussed above, may be practiced with steps and/or operations in a different order, and/or with hardware elements in configurations, which are different than those which are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

1. A computer-implemented method, comprising:
in response to receiving a migration request of a source Linux machine to a target Linux machine, discovering, by a server system, a plurality of software packages installedon the source Linux machine;
validating, by the server system, the plurality of software packages based, at least in part,on validation dataset stored in a database and information associated with the plurality of software packages, the information comprising configuration and data paths associated with the plurality of software packages within the source Linux_machine;
in response to successful validation_of at least one software package of the plurality ofsoftware packages, storing, by the server system, snapshot of the at least one software package into the database;
migrating, by the server system, the_at least one software package to thetarget Linux machine based, at least in part, on the stored snapshot of the at least one software package;
determining, by the server system, whether versions and/or Linux distributions of thesource Linux machine and the target Linux machine are different or not, and in response to determining that versions and/or Linux distributions of the source Linux machine and the target Linux machine are different, translating, by the server system, the at least one-software package into equivalent software package compatible with the target Linux machine; and
restoring, by the server system, the at least one software package to the target Linux machine.

2. The computer-implemented method as claimed in claim 1, wherein the validation dataset comprises configuration and data paths of a set of software packages learnt inthe past discovery processes for Linux systems.

3. The computer-implemented method as claimed in claim 2, wherein validating the plurality of software packages comprises:
comparing, by the server system, the configuration and data paths associated with theplurality of software packages and the validation dataset; and
determining, by the server system, validation scores of the plurality of software packagesbased, at least in part, on a machine learning model and the comparing step.

4. The computer-implemented method as claimed in claim 3, further comprising:
in response to determining that a validation score of a particular software package is lessthan a predetermined threshold value, prompting, by the server system, a user input for validating the particular software package.

5. The computer-implemented method as claimed in claim 1, wherein migrating the at least one software package to the target Linux machine comprising:
accessing, by the server system, the stored snapshot of the at least one software package of the source Linux machine from the database; and
validating, by the server system, the plurality of software packages based, at least in part,on the validation dataset and the stored snapshot of the at least one software package.

6. (canceled)

7. (canceled)

8. A server system, comprising:a communication interface;
a memory comprising executable instructions; and
a processor communicably coupled to the communication interface, the processor configured to execute the executable instructions to cause the server system to at least:
responsive to receipt of a migration request of a source Linux_machine_to a target Linux machine, discover a plurality of software packages installed on the source Linux machine,
validate the plurality of software packages based, at least in part, on validation dataset stored in a database and information associated with the plurality ofsoftware packages, the information comprising configuration and data paths associatedwith the plurality of software packages within the source Linux machine,
in response to successful validation_of at least one software package of the plurality of software packages, store snapshot of the at least one softwarepackage into the database, and
migrate the at least one software package to the target Linux_machinebased, at least in part, on the stored snapshot of the at least one software package;
determine whether versions and/or Linux distributions of the source Linux machineand the target Linux machine are different or not, and in response to a determination that versions and/or Linux distributions of the source Linux machine and the target Linux machine are different, translate the at least onesoftware package into equivalent software package compatible with the target Linux machine; and
restore the at least one software package to the targetLinux machine.

9. The server system as claimed in claim 8, wherein the validation dataset comprises configuration and data paths of a set of software packages learnt in the past discovery processes for Linux systems.

10. The server system as claimed in claim 9, wherein for validating the plurality of software packages, the server system is further caused to:
compare the configuration and data paths associated with the plurality ofsoftware packages and the validation dataset, and
determine validation scores of the plurality of software packages based, at least in part,on a machine learning model and the comparison.

11. The server system as claimed in claim 10, wherein the server system is furthercaused to:
in response to a determination that a validation score of a particular software package is less than a predetermined threshold value, prompt a user input to validate the particular softwarepackage.

12. The server system as claimed in claim 8, wherein, to migrate the_at least one software package to the target Linux machine, the server systemis further caused to:
access the stored snapshot of the at least one software package of the source Linux machine from the database; and
validate the plurality of software packages based, at least in part, on the validation dataset and the stored snapshot of the at least one software package.

13. (canceled) 14. (canceled)

15. -20. (canceled)
